(19) United States
(12) Patent Application Publication
(10) Pub. No.: US 2026/0232525 A1
(43) Pub. Date: Aug. 13, 2026

(54) WEARABLE ADJUSTABLE BACK VIBRATOR SYSTEM AND METHOD

(71) Applicant: Kevin Rawls, Columbia, MS (US)

(72) Inventor: Kevin Rawls, Columbia, MS (US)

(21) Appl. No.: 19/048,801

(22) Filed: Feb. 7, 2025

(51) Int. Cl. A61H 23/02; A61H 15/00

(52) U.S. Cl. CPC A61H 23/02; A61H 15/0078; A61H 2201/0157; A61H 2201/1207; A61H 2201/1621; A61H 2201/165; A61H 2201/1692; A61H 2201/5007; A61H 2205/081

(57) ABSTRACT

A wearable adjustable back vibrator system and method for applying beneficial controlled pressing and scratching motion to the back of a user. A washable removable shell in the form of a vest, having a shell front closure, encloses band structures having several oscillating units placed so as to be in contact with various portions of the user's back. Each oscillating unit has several protuberances to contact the user's back. A controller controls each oscillating unit independently in accord with the user's input through a user-control unit. A power unit provides electric power for operation. The user-control unit can be connected to the controller through a cable or through a wireless connection using a user-control communications unit and controller communications unit.

### BACKGROUND OF THE INVENTION

This invention provides a wearable adjustable back vibrator system and method for applying beneficial controlled pressing and scratching motion to the back of a user.

Some persons, and in some circumstances, experience soreness, itching, tingling, neuropathy, or other discomfort in or on their back, but do not have the opportunity or perhaps ability to rub or scratch their back or to move into position to rub their backs against a stationary object for relief. Pressing on the back, either percussively or more gradually, and rubbing, stroking, or scratching the back can provide relief. Persons with limited mobility and range of movement, and persons with conditions like diabetes might experience a high amount of itchiness and discomfort, but might have a low level of ability to reach and address that discomfort. Even a person with normal range of movement might encounter circumstances limiting any ability to shift positions or use the hands and arms to reach the back.

Sometimes discomfort in the back occurs over a large portion or the whole back, and sometimes discomfort is felt in one or more discreet areas. Different types of itchiness or discomfort are often best addressed with different types of pressing, rubbing, or scratching actions, and different speeds and intensities of the actions.

When applying pressure to the back, it is important to avoid placing improper pressure or strain on the spine. Although a qualified professional might be able to manipulate the spine in a safe manner, it is best for persons putting pressure on their own backs or others'backs, and for any devices or machines putting pressure on any back, to completely avoid applying any pressure or strain to the spine in order to avoid injuring the spine.

What is needed is a wearable adjustable back vibrator to apply different pressing, rubbing, and scratching motions, at different speeds, intensities, and durations, to different areas of the back, in a safe and controlled way, in the ultimate control of the user according to the specific discomfort being experienced.

U.S. Pat. No. 10,874,579 for a “Wearable Massager,” issued on Dec. 29, 2020 to inventor Reginald Rembert, provides for a wearable massager including a plurality of attachments, each of which is designed for a specific body part. Each attachment includes at least one massaging module on an inner surface that is either formed of mechanical rollers that simulate a massage as they are moved vertically and horizontally, or a plurality of contiguous, inflatable bladders that simulate a massage as they are inflated and rapidly deflated. A controller allows a user to vary the speed and intensity with which the rollers are moved horizontally and vertically, or the level, order, and frequency in which each bladder is inflated and deflated. Accordingly, the continuous movement of the rollers or inflation and deflation of the bladders against the wearer's skin simulates the typical movements of a massage therapist's hands and fingers.

US Publication No. 2022/0062090 for a “Back Massage Vest,” published on Mar. 3, 2022 by inventor Jamel L. Chisolm, discloses a back massaging device intended to provide users with a vest that includes massaging units inbuilt within the vest. More specifically, it is an aim of the device to provide an inbuilt massaging unit with massaging arms that can travel from the shoulders to the lower back of the user. To accomplish this, the device includes two massaging units that can traverse J-shaped tracks inbuilt within the vest. In other words, the back massaging vest allows for a portable massaging device for users on the go or want to do other activities while having the comfort of a massage. The massaging arms in particular traverse a track that allow full coverage of the user's back. Further, the massaging device may be wirelessly controlled with a remote control or a wireless communication device.

Chinese Publication No. 114145514 for a “Health-Care Nursing Vest,” published on Mar. 8, 2022, discloses a health-care conditioning intelligent nursing vest, which comprises a vest structure comprising a front panel, a rear panel, and connecting bands, wherein the two connecting bands are symmetrically and fixedly connected with the front panel and the rear panel.

Chinese Publication No. 106806106 for “A Kind of Massaging Vest,” published on Jun. 9, 2017, discloses a massage mechanism arranged in an interlayer at the back of a vest body.

International Publication No. 2024/071515 for a “Wearable Massager Equipped with Multi-Type Massage Modules,” published on Apr. 4, 2024 by applicant JUBILEE BIOTECH CO., LTD., discloses a wearable massager equipped with multi-type massage modules. According to an embodiment, the massager comprises: a body portion to be worn on the body of a user; and a plurality of massage modules which are arranged on the body portion and massage the body of the user. The massage modules comprise: a first massage module that massages the shoulders of the user; a second massage module that massages the armpits of the user; and a third massage module that massages the collarbone of the user, and as the user wears the body portion, the plurality of massage modules may be positioned on the shoulders, the collarbone, and the armpits, respectively.

US Publication No. 2020/0188224 for a “Massage Vest Assembly,” published on Jun. 18, 2020 by inventor Cindy Mountjoy, discloses a massage vest assembly for providing automatic therapeutic massage. The assembly includes a vest that is worn on a user's torso. A plurality of massage units is each coupled to the vest to engage and thus massage the user's torso when the vest is worn. The plurality of massage units includes a set of shoulder massage units and a set of spine massage units. A control is provided and the control is positionable within a respective one of the pockets. The control is electrically coupled to each of the massage units such that the control unit turns each of the massage units on and off.

US Publication No. 2023/0346636 for a “Garment with Massaging Vibrating Devise Mechanism,” published on Nov. 2, 2023 by inventor Juliet P. Graham, discloses a wearable apparatus and method that provides the benefits of a portable massager, exerciser, and circulation machine for strengthening and rejuvenating all areas of the body from neck to ankles. The apparatus is the combination of garments interconnecting with massaging devises, creating a full body massage mechanism that enhances health, fitness, and wellness. The garments are equipped with varying massage types and intensity, including heating therapy, air compression, bi-directional rolling/kneading apparatus, and mini vibrators/massagers embedded in strategic parts of the garments, to provide the maximum effect to the various pressure points of the user's body. The deep penetration jacket is the foundation for deep kneading, rolling, and percussion massages. Benefits to the users include relief from aches and pains, muscle cramps, stress, stimulation of circulation, assisting in the improvement and regeneration of some conditions, and includes aiding in the betterment of other physical limitations.

U.S. Pat. No. 7,207,953 for a “Massage Therapy Vest,” issued on Apr. 24, 2007 to inventor Irene Goicaj, provides for a wearable massage apparatus formed from a main body having a first side. At least one massage head is positioned on the first side of the body. The apparatus further includes an arrangement for securing the main body to a user. A control module is connected to the at least one massage head for controlling movement thereof. The massage head on the first side of the main body is positioned adjacent to the user's body and upon being secured thereto by the securing arrangement, the control module is selectively activated thereby causing the at least one massage head to oscillate and massage the user.

### SUMMARY OF THE INVENTION

This invention provides a wearable adjustable back vibrator system and method for applying beneficial controlled pressing and scratching motion to the back of a user.

The wearable adjustable back vibrator provides a washable removable shell in the form of a vest, having a shell front closure, and band structures around the vest, each having several oscillating units placed so as to be in contact with various portions of the user's back. Each oscillating unit has several protuberances to contact the user's back. A controller controls each oscillating unit independently in accord with the user's input through a user-control unit. A power unit provides electric power for operation. The user-control unit can be connected to the controller through a cable or through a wireless connection using a user-control communications unit and controller communications unit.

### BRIEF DESCRIPTION OF THE DRAWINGS

Reference will now be made to the drawings, wherein like parts are designated by like numerals, and wherein:

FIG. 1 is an isometric view of the wearable adjustable back vibrator of the invention;

FIG. 2 is an exploded view of the wearable adjustable back vibrator of the invention;

FIG. 3 is a section view of the inside back portion of the wearable adjustable back vibrator of the invention;

FIG. 4 is an isometric view of an extension-cable embodiment of the wearable adjustable back vibrator of the invention; and

FIG. 5 is an isometric view of a communications-unit embodiment of the wearable adjustable back vibrator of the invention.

### DETAILED DESCRIPTION OF THE INVENTION

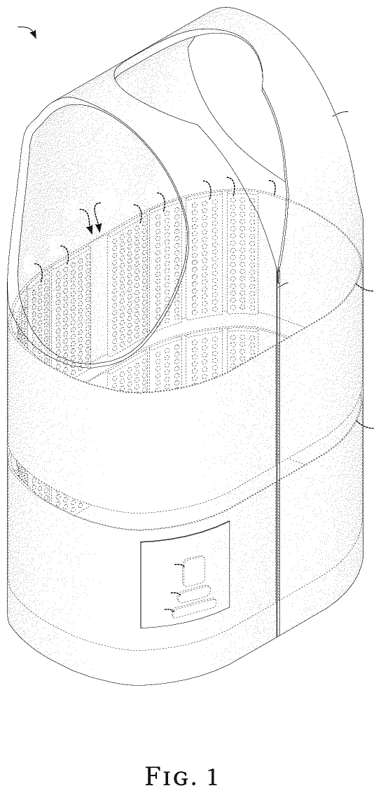

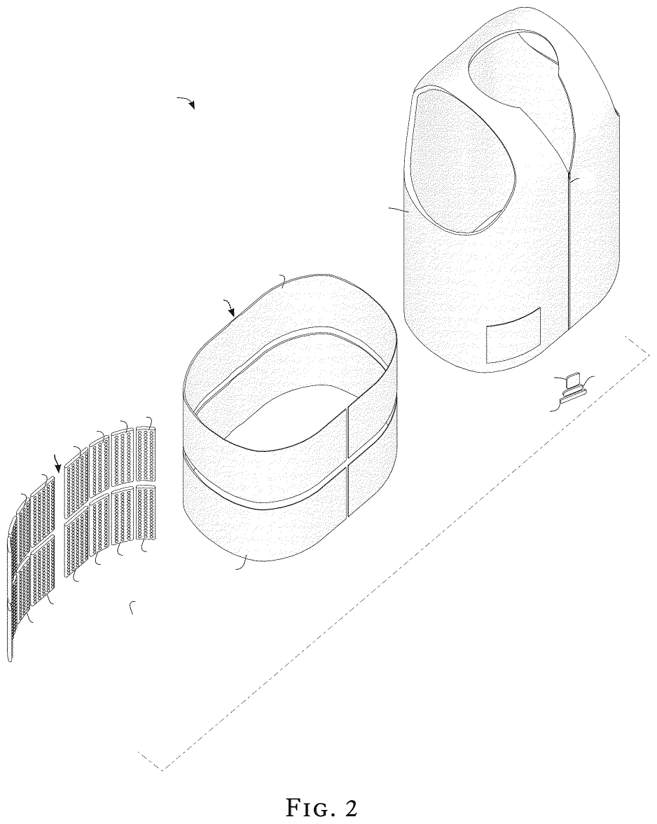

Referring to FIG. 1 and FIG. 2, the wearable adjustable back vibrator 10 system and method of the invention provides a removable shell 1 having the form of a vest meant to be worn on the user's torso. This removable shell 1 can be taken off the other components of the system, and can be washed or cleaned separately, and then can be placed back on the other components. The removable shell 1 provides a front closure 11 such as the illustrated zipper or other closures such as buttons or snaps as known in the art. In use, worn on the user's torso, the wearable adjustable back vibrator 10 has an orientation corresponding to the user's torso, having a vertical up-and-down axis, a circumference around the vertical axis, and a front and back.

In the illustrated preferred embodiment two band structures 2 are provided within the removable shell 1, each band structure 2 describing a substantial circumference around the user's torso in use, although an embodiment having only one band structure is possible. Embodiments having more than two band structures 2 are also possible and would function on the same principles. Each band structure 2 has open ends corresponding to the front opening and front closure 11 of the removable shell 1 of the vest. In use, the open ends of the band structures 2 are held together by the front closure 11 of the vest, and the band structures 2 pull the back of the vest toward the front of the vest so as to pull the back of the vest against the user's back with a controlled and safe force. The band structures 2 can be made of an elastic or stretchable material throughout the band, or can be made with both stretchable and non-stretchable portions, such as having a stiffer back portion and more elastic side portions. The band structures 2 are placed with one above and one below on the vertical axis of the vest, with a space between the two band structures, as shown. The two separated band structures 2 and the space between them allow for better fitting to the user's back, and allow for movement and bending of the user's torso during use. The band structures 2 could be attached or partially attached to each other in such a way that does not impede their operation as separate units. Each band structure 2 provides a spine-avoidance area 21 at the portion corresponding to the user's spine, meant to prevent and avoid exertion of pressure on the user's spine. In embodiments using more stiff or rigid materials for the back portion of the band structures 2 the spine-avoidance area 21 might be formed by removing or thinning the material, as shown, or by adding padding to that area.

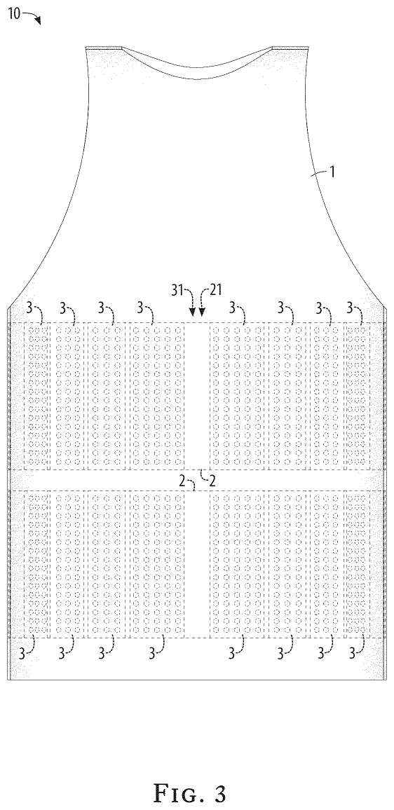

Referring additionally to FIG. 3, several oscillating units 3 are arrayed along the back portions of the band structures 2 as shown. A spine-avoidance gap 31 corresponding to the spine-avoidance area 21 of the band structures 2 is provided to avoid placement of any oscillating unit 3 in contact with the user's spine. Different sizes, shapes, and configurations of oscillating units 3 can be placed to correspond to different areas of the user's back. The illustrated embodiment shows four quadrants, with each quadrant having four oscillating units 3 extending from near the spine toward and partially around the sides. Each oscillating unit 3 can operate independently of, or in controlled coordination with the others, as treated in detail below. The wearable adjustable back vibrator 10 can therefore be used to operate on a specific area or areas of the back, or to operate in various patterns across the whole back or portions of the back.

Each oscillating unit 3 is provided with an oscillating driver such as electric motors and drivers known in the art. The oscillating driver is sealed within the oscillating unit 3 to prevent damage to the driver or injury to the user. The oscillating unit 3 should provide an oscillating movement in substantially the plane of the face of the unit, which would correspond to the plane of the user's back, with up-and-down and side-to-side motion. Optionally, additional front-to-back or in-and-out oscillation can be provided, either with a second oscillating driver or with an oscillating driver capable of providing the additional movement. In a preferred embodiment the oscillating driver of the oscillating unit 3 can also provide controllable variations in speed and intensity of movement.

Each oscillating unit 3 is provided with several protuberances extending from the face of the oscillating unit 3 which faces the user's back. In the illustrated embodiment these protuberances are spheres or balls mounted partially behind the face of the oscillating unit 3 and partially extending from the face, and are able to spin or roll along the user's back as the unit oscillates. In other embodiments the protuberances can be nubs, studs, or fingers of a material such as silicone rubber. A combination of rolling and non-rolling protuberances can also be provided. The spinning or rolling protuberances allow for more vigorous oscillation of the unit without an uncomfortable level of friction against the back, where the non-rolling protuberances provide a more effective rubbing or scratching action.

Operation of the wearable adjustable back vibrator 10 is controlled by a controller 4, using electric power from a power unit 5, such as an electric battery or similar electric-storage device such as a supercapacitor. The controller 4 activates, deactivates, and controls the intensity and pulsing of the several oscillating units 3, with each oscillating unit 3 being addressed independently, which allows for operation on only a specific area of the back, or for a pulse or wave of operation across the back. A user-control unit 6 is provided for the user to control specific modes of operation executed by the controller 4. The power unit 5 can be a rechargeable electric battery such as standard batteries used in consumer electronics. Such batteries can be recharged by standard means and by other means such as separate battery packs or boosters or by solar panels. The controller 4, power unit 5, and user-control unit 6 can be placed within the removable shell 1 of the vest such as inside a pocket or behind a patch as illustrated.

In use, the user can input the areas of the users back to be addressed, and the type, duration, and optionally the speed and intensity of the oscillation to be effected, through the user-control unit 6 of the controller 4, which in turn provides electric power and any necessary command signals to each individual involved oscillating unit 3, which undergo the proper movements to move the protuberances of the oscillating unit 3 against the user's back in the desired percussive, rubbing, or scratching motion.

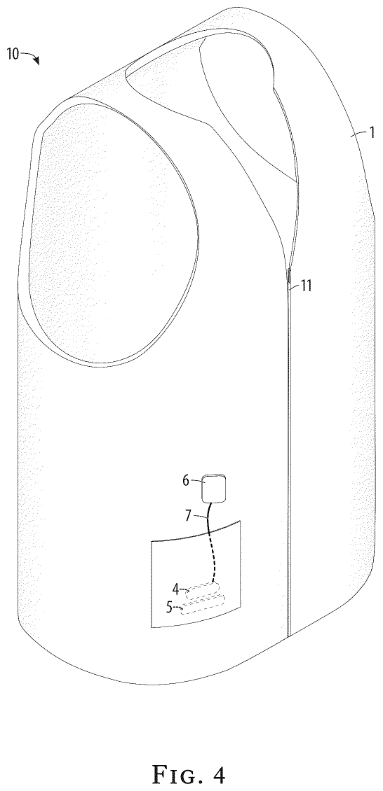

Referring to FIG. 4, the user-control unit 6 can be implemented as a hand-held unit connected to the controller 4 by means such as a wire or cable such as the control extension cable 7 shown, which allows for the user-control unit 6 to be brought outside the pocket or patch for ease of operation.

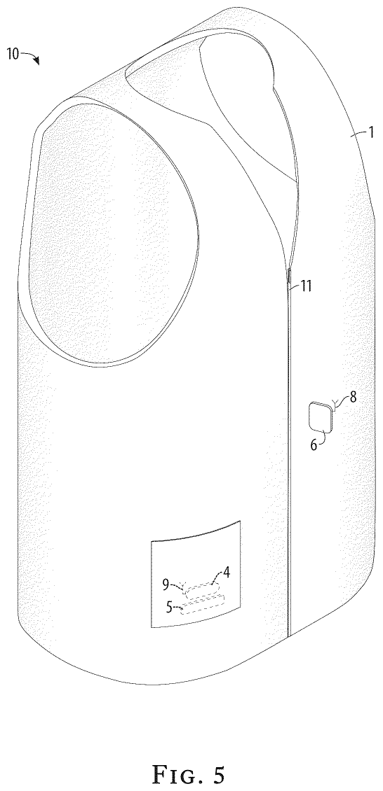

Referring to FIG. 5, the user-control unit 6 can also be implemented as a remote hand-held unit communicating with the controller 4 through wireless means such as a user-control communications unit 8 on the user-control unit 6 and a controller communications unit 9 on the controller 4, as illustrated. The wireless communications between the user-control communications unit 8 and controller communications unit 9 can be a standard radio-frequency (RF) protocol on appropriate frequency bands, such as BLUETOOTH® or WI-FI® protocols, or a proprietary protocol. For embodiments providing an appropriate controller communications unit 9 on the controller 4, the user-control unit 6 can also be implemented on a standard smartphone or similar device such as a tablet by standard methods, allowing for user control of the wearable adjustable back vibrator 10 through the standard smartphone.

Many other changes and modifications can be made in the system and method of the present invention without departing from the spirit thereof. I therefore pray that my rights to the present invention be limited only by the scope of the appended claims.

I claim:

1. A wearable adjustable back vibrator system comprising:
(i) a removable shell having a front closure;
(ii) at least one band structure having a spine-avoidance area;
(iii) a plurality of oscillating units arrayed upon each said band structure leaving a spine-avoidance gap, each oscillating unit having a plurality of protuberances;
(iv) a controller adapted to control operation of each said oscillating unit;
(v) a power unit adapted to provide power for operation; and
(vi) a user-control unit adapted to allow user control through said controller.

2. The wearable adjustable back vibrator system of claim 1, further comprising two said band structures.

3. The wearable adjustable back vibrator system of claim 1, where said protuberances of said oscillating units further comprise rolling protuberances.

4. The wearable adjustable back vibrator system of claim 1, where said protuberances of said oscillating units further comprise non-rolling protuberances.

5. The wearable adjustable back vibrator system of claim 1, where said power unit further comprises a rechargeable battery.

6. The wearable adjustable back vibrator system of claim 1, further comprising a control extension cable between said user-control unit and said controller.

7. The wearable adjustable back vibrator system of claim 1, where said removable shell is washable.

8. The wearable adjustable back vibrator system of claim 1, further comprising a user-control communications unit on said user-control unit and a controller communications unit on said controller, adapted to provide wireless communications.

9. The wearable adjustable back vibrator system of claim 1, where said user-control unit is implemented on a smartphone.

10. A wearable adjustable back vibrator system comprising:
(i) a removable shell having a front closure;
(ii) at least two band structures, each having a spine-avoidance area, positioned above and below other said band structures with a space between said band structures;
(iii) a plurality of oscillating units arrayed upon each said band structure leaving a spine-avoidance gap, each oscillating unit having a plurality of protuberances;
(iv) a controller adapted to control operation of each said oscillating unit;
(v) a power unit adapted to provide power for operation; and
(vi) a user-control unit adapted to allow user control through said controller.

11. The wearable adjustable back vibrator system of claim 10, further comprising two said band structures.

12. The wearable adjustable back vibrator system of claim 10, where said protuberances of said oscillating units further comprise rolling protuberances.

13. The wearable adjustable back vibrator system of claim 10, where said protuberances of said oscillating units further comprise non-rolling protuberances.

14. The wearable adjustable back vibrator system of claim 10, where said power unit further comprises a rechargeable battery.

15. The wearable adjustable back vibrator system of claim 10, further comprising a control extension cable between said user-control unit and said controller.

16. The wearable adjustable back vibrator system of claim 10, where said removable shell is washable.

17. The wearable adjustable back vibrator system of claim 10, further comprising a user-control communications unit on said user-control unit and a controller communications unit on said controller, adapted to provide wireless communications.

18. The wearable adjustable back vibrator system of claim 10, where said user-control unit is implemented on a smartphone.

19. A wearable adjustable back vibrator method comprising:
(i) providing a wearable adjustable back vibrator system comprising:
(a) a removable shell having a front closure;
(b) at least one band structure having a spine-avoidance area;
(c) a plurality of oscillating units arrayed upon each said band structure leaving a spine-avoidance gap, each oscillating unit having a plurality of protuberances;
(d) a controller adapted to control operation of each said oscillating unit;
(e) a power unit adapted to provide power for operation; and
(f) a user-control unit adapted to allow user control through said controller;
(ii) wearing said wearable adjustable back vibrator system as a vest;
(iii) closing said front closure of said removable shell, thereby pulling said oscillating units into place against the user's back; and
(iv) activating said wearable adjustable back vibrator system by the user, through said user-control unit, for specific areas of the back and types of motion.
